(19) United States
(12) Patent Application Publication
(10) Pub. No.: US 2013/0136939 A1
(43) Pub. Date: May 30, 2013

(54) METHOD FOR FORMING A SHAPE OF AN ELECTRO-OPTICAL COMPONENT OR PHOTOVOLTAIC COMPONENT

(71) Applicant: Chak Seng Leung, Hong Kong (CN)

(72) Inventor: Chak Seng Leung, Hong Kong (CN)

(73) Assignee: TOUCH CENTURY ELECTRONIC LTD., Hong Kong (CN)

(21) Appl. No.: 13/304,864

(22) Filed: Nov. 28, 2011

(51) Int. Cl. B29B 7/00; B24B 1/00

(52) U.S. Cl. 428/542.8; 451/36

(57) ABSTRACT

A method for forming a shape of an electro-optical component or photovoltaic component, the method comprising: ultrasonically cutting a substrate using an ultrasonic cutting machine having a holder adapter operatively connected to a shape mould having a contact edge corresponding to the shape, the contact edge making contact with the substrate at a contact region; and spraying a grinding fluid to the contact region; wherein after a predetermined amount of time of ultrasonically cutting the substrate, the component is formed corresponding to the shape.

### TECHNICAL FIELD

The invention concerns a method for forming a shape of an electro-optical component or photovoltaic component

### BACKGROUND OF THE INVENTION

A laser cutter, Computer Numerical Control (CNC) diamond driller, diamond drilling machine and diamond grinding disk are commonly used to make shape formation. Laser cutting is expensive for consumer product applications in the watch industry. A CNC diamond driller is limited by the radius of the diamond driller to form both internal and external fine details of a silhouette edge of watch design. A diamond drill can only make internal holes of a small size instead of a silhouette edge, or hole size of a large size that will damage the structure of components. A diamond grinding disk cannot work for accurate and fine details of an external silhouette edge, and is not possible for forming an internal shape.

The needs in LCD shape form have been changing from square or rectangular to circular or irregular shapes depending on the designers of consumer products. This is particularly the case for watch designs in the watch industry.

It is desirable to provide a method for forming free shapes in a flexible and cost-effective manner.

### SUMMARY OF THE INVENTION

In a first preferred aspect, there is provided a method for forming a shape of an electro-optical component or photovoltaic component, the method comprising:
ultrasonically cutting a substrate using an ultrasonic cutting machine having a holder adapter operatively connected to a shape mould having a contact edge corresponding to the shape, the contact edge making contact with the substrate at a contact region; and
spraying a grinding fluid to the contact region;
wherein after a predetermined amount of time of ultrasonically cutting the substrate, the component is formed corresponding to the shape.

The shape mould may be made of stainless steel and the substrate is made from glass.

The grinding fluid may be a mixture of a fluid and a material that is harder than the material of the substrate.

The grinding fluid may be a mixture of water and carborundum powder, and the substrate is made from glass.

The shape mould may be operatively connected to the holder adapter by braze welding.

The holder adapter may be mounted to the ultrasonic cutting machine.

The shape may be any one from the group consisting of: circle, square, rectangle and irregular shape.

In a second aspect, there is provided a system for forming a shape of an electro-optical component or photovoltaic component, the system comprising:
an ultrasonic cutting machine configured to ultrasonically cut a substrate, the ultrasonic cutting machine having a holder adapter operatively connected to a shape mould having a contact edge corresponding to the shape, the contact edge making contact with the substrate at a contact region; and
grinding fluid to be sprayed onto the contact region;
wherein after a predetermined amount of time of ultrasonically cutting the substrate, the component is formed corresponding to the shape.

In a third aspect, there is provided an electro-optical component or photovoltaic component having a shape formed by the method according to claim 1.

This present invention provides an improved method for cutting electro-optical or photovoltaic components into internal or external irregular shapes. In certain industries, the irregular shapes are required so that the components can fit in a specially designed casing of a product.

For example, watches and timepieces perform the function of time keeping as well as being a fashion accessory. The electronic parts of a watch, such as the liquid crystal display and solar cell (both are electro-optical or photovoltaic components), are designed for a watch which needs to have a special shape to suit a particular watch design. This special shape must be cut accurately so that the electronic part fits for the watch industry, and therefore requires great skill dependent. Nowadays, the watch industry requires cutting accuracy and silhouette edge/outline edge free cutting which can be performed cost-effectively.

### BRIEF DESCRIPTION OF THE DRAWINGS

An example of the invention will now be described with reference to the accompanying drawings, in which:

FIG. 1 is a perspective view of a shape mould used in a process for forming a shape of an electro-optical component or photovoltaic component in accordance with an embodiment of the present invention;

FIG. 2 is a perspective view of the shape mould of FIG. 1 operatively attached to a holder adapter of an ultrasonic cutting machine;

FIG. 3 is a perspective view of the connected shape mould and holder adapter when connected to the ultrasonic cutting machine of FIG. 2 flipped vertically;

FIG. 4 is a perspective view of grinding fluid being sprayed between the shape mould and substrate;

FIG. 5 is a perspective view of the shape mould ultrasonically cutting the substrate;

FIG. 6 is a perspective view of the electro-optical component or photovoltaic component cut in the shape corresponding to the shape mould; and

FIG. 7 is a process flow diagram of the process for forming a shape of an electro-optical component or photovoltaic component in accordance with an embodiment of the present invention.

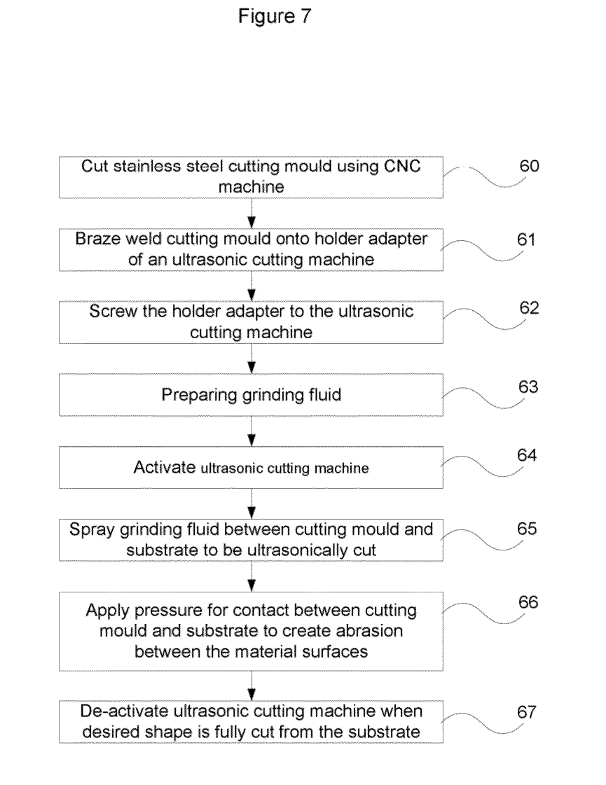

### DETAILED DESCRIPTION OF THE DRAWINGS

Referring to the drawings, a method for forming a shape of an electro-optical component 59 or photovoltaic component 59 is provided. The method generally comprises ultrasonically cutting a substrate 40 using an ultrasonic cutting machine.

The ultrasonic cutting machine has a holder adapter 20. The holder adapter 20 is operatively connected to a shape mould 10. The shape mould 10 has a contact edge 11 corresponding to the final shape for the electro-optical component or photovoltaic component. The contact edge 11 is generally a planar surface. The contact edge 11 makes contact with the substrate 40 at a contact region 42. The method also comprises spraying a grinding fluid 41 to the contact region 42 while the ultrasonic cutting machine is operational. After a predetermined amount of time of ultrasonically cutting the substrate 40, the component 59 is formed corresponding to the shape of the contact edge 11 of the shape mould 10.

The method enables irregular shape formation of electro-optical components and photovoltaic components. The method also includes: mould cutting, mould brazing, preparation of the grinding fluid and component cutting.

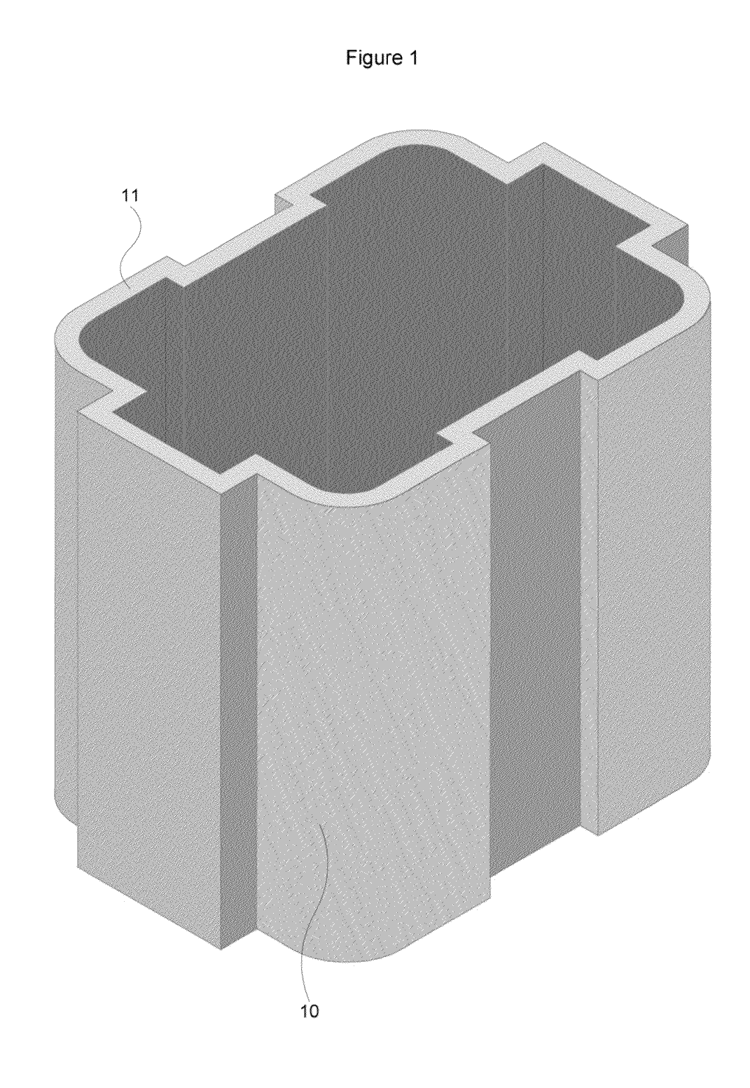

Referring to FIG. 1, the cutting mould 10 for cutting components is made from stainless steel. The cutting mould 10 is cut (60) according to a computer design drawing with aid of Computer Numerical Control (CNC) wire-cut machine. The final internal contour outline is the same as the computer design drawing with a contour wall at least 1 mm thick and a height at least 50 mm or more . The thickness of the contour wall is the contact edge 11 of the shape mould 10.

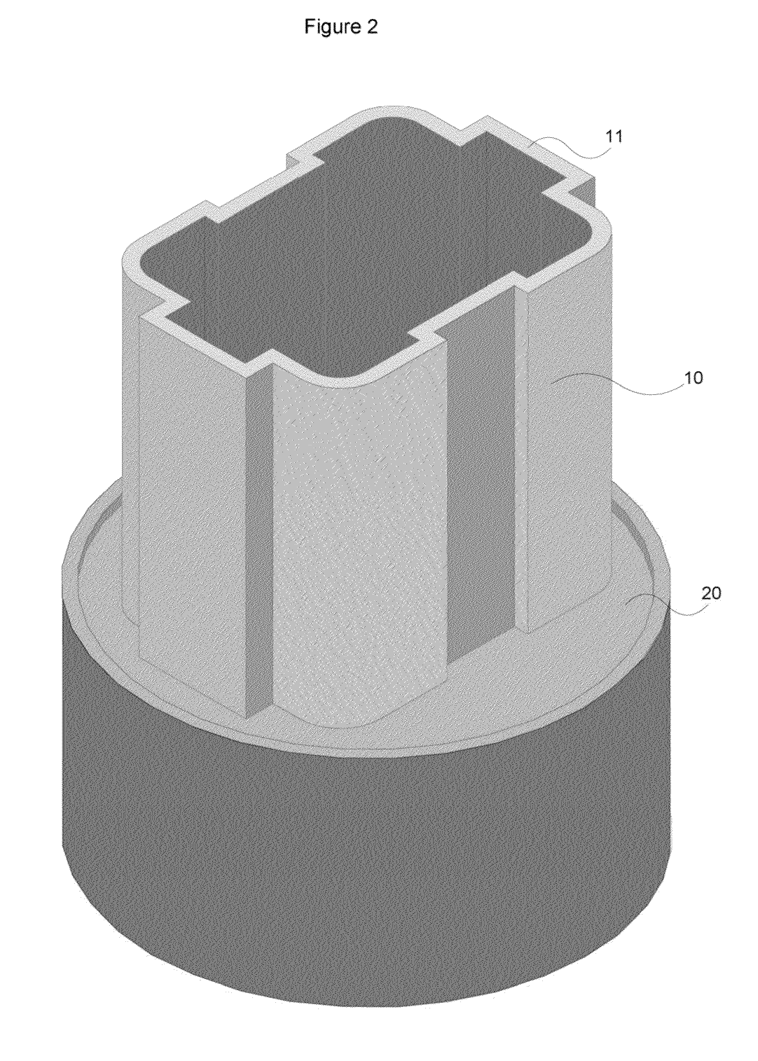

Referring to FIG. 2, the cutting mould 10 is braze-welded (61) on the holder adapter 20 of the ultrasonic cutting machine (not shown).

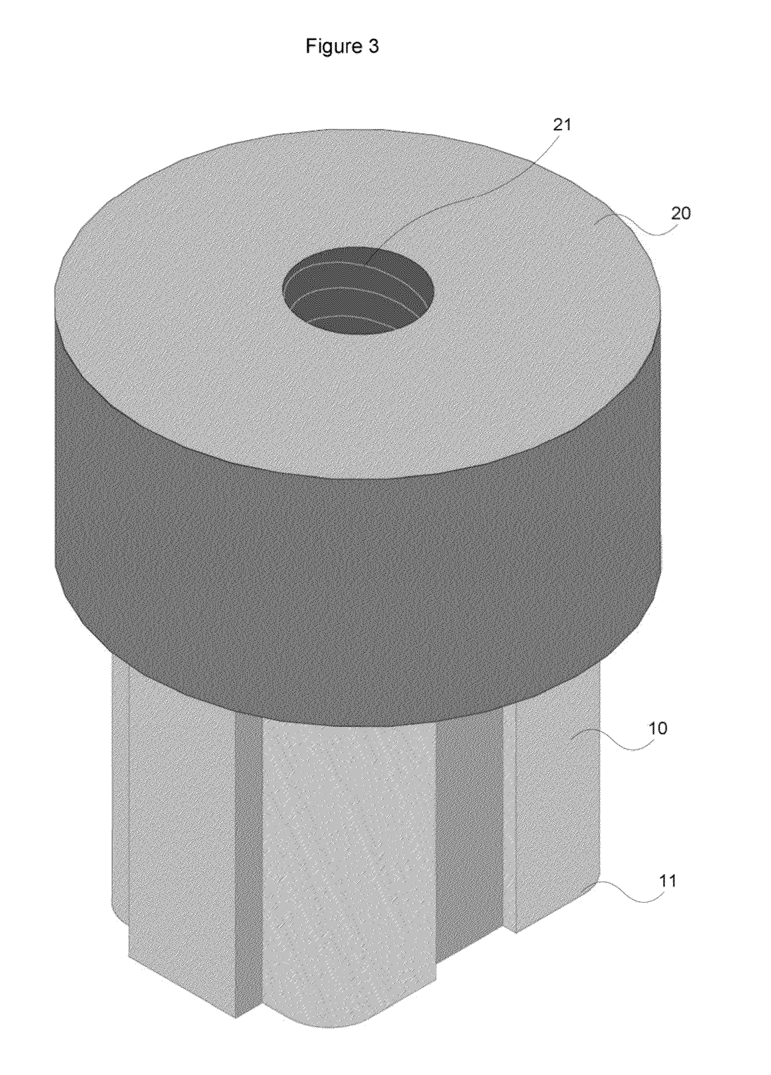

Referring to FIG. 3, the holder adapter 20 with the braze-welded cutting mould 10 is screw-mounted (62) onto the ultrasonic cutting machine (not shown) via an internal screw thread 21 of the holder adapter 20. The contact edge 11 of the cutting mould 10 is oriented to face downward.

The grinding fluid 41 is prepared (63) which is a mixture of water and carborundum powder, The ratio of components for the mixture by weight is around ten portions of water to one portion of carborundum powder.

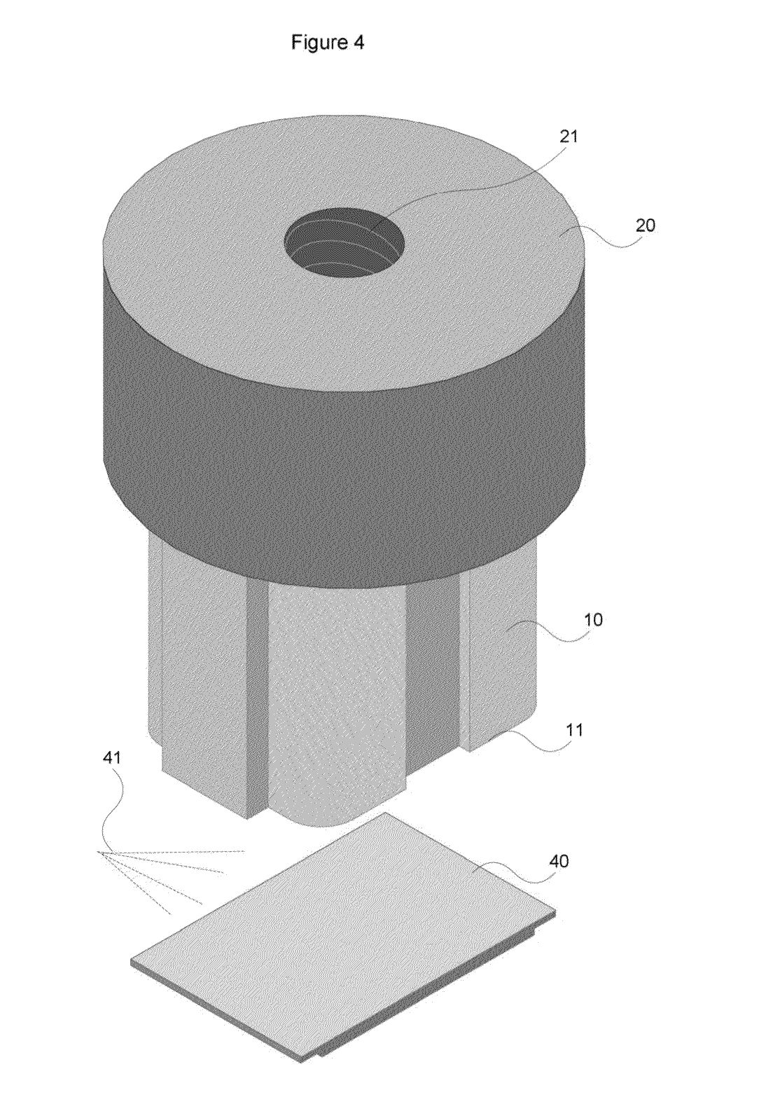

Referring to FIG. 4, the ultrasonic cutting machine is activated (64). Grinding fluid 41 is sprayed (65) between the cutting mould 10 and the component object/substrate 40 proximal to the likely contact region 42.

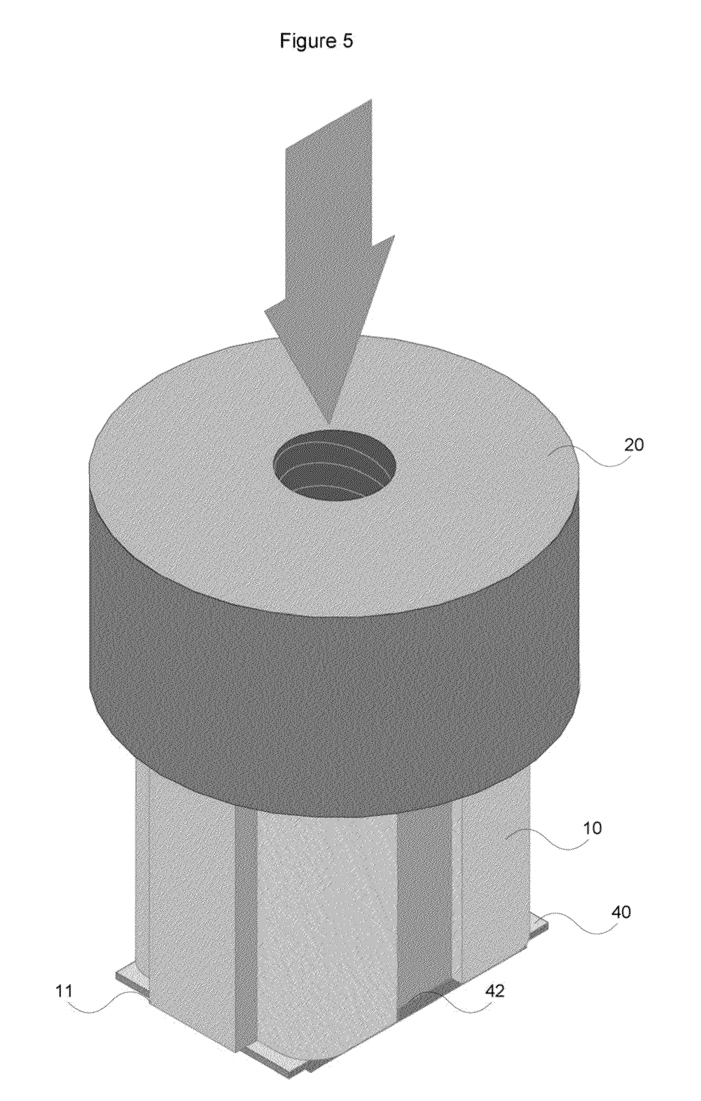

Referring to FIG. 5, appropriate downward pressure is applied (66) from the cutting mould 10 onto the component object/substrate 40 in such a way that the carborundum powder flows in the water medium of the grinding fluid 41 and the carborundum powder absorbs the ultrasonic energy and transforms to grinding energy which abrades the material of both the component object 40 and cutting mould 10 at the contact region 42. Although some of the stainless steel material of the cutting mould 10 is abraded, it may be re-used repeatedly until there is insufficient height for the cutting mould 10 to be useful anymore. In that case, another cutting mould 10 can be made using the steps described earlier.

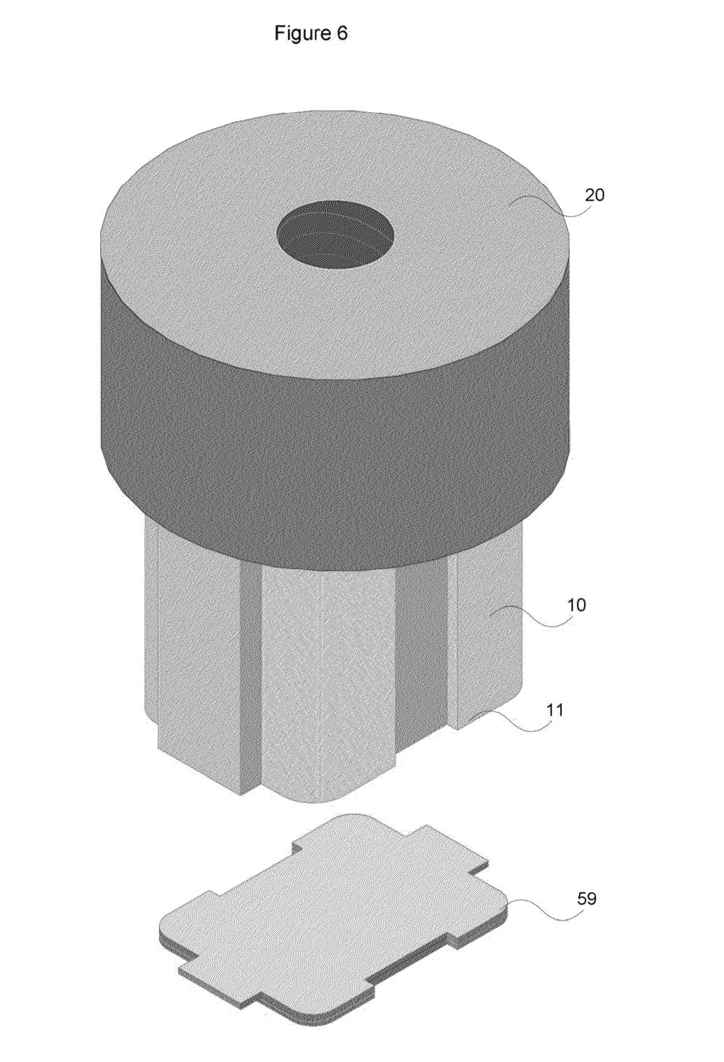

Referring to FIG. 6, the ultrasonic cutting process is stopped (67) when the component object 40 has been fully cut through and the shape is formed. The cutting mould 10 is raised from the component object 40 and the component 59 that is cut from the original component object 40 in the shape corresponding to the contact edge 11 of the shape mould 10 is removed.

It will be appreciated by persons skilled in the art that numerous variations and/or modifications may be made to the invention as shown in the specific embodiments without departing from the scope or spirit of the invention as broadly described. The present embodiments are, therefore, to be considered in all respects illustrative and not restrictive.

We claim:

1. A method for forming a shape of an electro-optical component or photovoltaic component, the method comprising:
ultrasonically cutting a substrate using an ultrasonic cutting machine having a holder adapter operatively connected to a shape mould having a contact edge corresponding to the shape, the contact edge making contact with the substrate at a contact region; and
spraying a grinding fluid to the contact region;
wherein after a predetermined amount of time of ultrasonically cutting the substrate, the component is formed corresponding to the shape.

2. The method according to claim 1, wherein the shape mould is made of stainless steel and the substrate is made from glass.

3. The method according to claim 1, wherein the grinding fluid is a mixture of a fluid and a material that is harder than the material of the substrate.

4. The method according to claim 3, wherein the grinding fluid is a mixture of water and carborundum powder, and the substrate is made from glass.

5. The method according to claim 1, wherein the shape mould is operatively connected to the holder adapter by braze welding.

6. The method according to claim 1, wherein the holder adapter is mounted to the ultrasonic cutting machine.

7. The method according to claim 1, wherein the shape is any one from the group consisting of: circle, square, rectangle and irregular shape.

8. A system for forming a shape of an electro-optical component or photovoltaic component, the system comprising:
an ultrasonic cutting machine configured to ultrasonically cut a substrate, the ultrasonic cutting machine having a holder adapter operatively connected to a shape mould having a contact edge corresponding to the shape, the contact edge making contact with the substrate at a contact region; and
grinding fluid to be sprayed onto the contact region;
wherein after a predetermined amount of time of ultrasonically cutting the substrate, the component is formed corresponding to the shape.

9. An electro-optical component or photovoltaic component having a shape formed by the method according to claim 1.
